(19) United States
(12) Patent Application Publication
(10) Pub. No.: US 2020/0065858 A1
(43) Pub. Date: Feb. 27, 2020

(54) INFORMATION PROVIDING SYSTEM, INFORMATION PROVIDING SERVER, AND INFORMATION PROVIDING METHOD

(71) Applicant: MITSUBISHI ELECTRIC CORPORATION, Tokyo (JP)

(72) Inventors: Saki NAKATSUMA, Tokyo (JP); Kazuhiko YAMADA, Tokyo (JP); Junji SUKENO, Tokyo (JP)

(73) Assignee: Mitsubishi Electric Corporation, Tokyo (JP)

(21) Appl. No.: 16/344,639

(22) PCT Filed: Sep. 27, 2017
(86) PCT No.: PCT/JP2017/034862

§ 371 Date: Apr. 24, 2019

(30) Foreign Application Priority Data
Jan. 16, 2017 (JP) 2017-004998

(51) Int. Cl. G06Q 30/02; G06F 8/65; H04L 29/08

(52) U.S. Cl. CPC G06Q 30/0261; G06F 8/65; H04L 67/04; H04L 69/329; H04L 29/08072

(57) ABSTRACT

An information providing system capable of providing beneficial content to a mobile information terminal carried by a user moving between areas includes the mobile information terminal and an information providing server. When transmission data is received, the information providing server extracts content corresponding to provision item information and category information included in the transmission data from a plurality of pieces of content included in a facility information table and transmits the extracted content to the mobile information terminal. When a switching request requesting transmission of content different from most recently received content is received, the information providing server extracts relevant category information relevant to category information corresponding to the most recently received content from a relevant category information table, extracts content corresponding to the relevant category information from the facility information table, and transmits the content corresponding to the relevant category information to the mobile information terminal.

### TECHNICAL FIELD

The present invention relates to an information providing system, an information providing server and an information providing method for providing beneficial content to a mobile information terminal carried by a user moving between areas.

### BACKGROUND ART

In recent years, it is possible to detect the position of a user carrying a mobile information terminal such as a smartphone by use of Global Positioning System (GPS) or short-range wireless communication such as Bluetooth (registered trademark) Low Energy (BLE). Further, it is also possible to detect motion of the user carrying the mobile information terminal since the mobile information terminal has various sensors such as an acceleration sensor and a gyro sensor installed therein. There has been known a system that provides a user with information corresponding to the position and the motion of the user by use of these technologies.

For example, Patent Reference 1 describes a system that calculates an area interest level indicating the degree and tendency of the user's interest in an area, based on behavioral condition of the user. This system calculates the area interest level regarding an area in which the user stayed based on the user's walking condition (walking, squatting, crouching, etc.) and area staying time detected with the GPS and the acceleration sensor of the mobile information terminal carried by the user and displays content on a screen of the mobile information terminal or a display device placed nearby based on the calculated area interest level.

### PRIOR ART REFERENCE

### Patent Reference

Patent Reference 1: WO 2011/114620

### SUMMARY OF THE INVENTION

### Problem to be Solved by the Invention

The system described in the Patent Reference 1 judges the area interest level based on the behavior of the user in the area in which the user stayed; however, a change in the user's interest occurring outside the area when the user is moving between areas or the like is not taken into consideration. For example, in a user in a shopping mall after purchasing intended clothing in a certain store (area) and exiting from the store, the interest in other stores selling clothes (other areas belonging to the same category handling the same merchandise) can have decreased and the interest in stores selling merchandise other than clothes (other areas belonging to a category handling different merchandise) can have increased. In such cases, the conventional system can continue providing the user with content related to the area or category in which the user's interest has already decreased.

An object of the present invention, which has been made to resolve the above-described problem, is to provide an information providing system, an information providing server and an information providing method capable of providing beneficial content to a mobile information terminal carried by a user moving between areas.

### Means for Solving the Problem

An information providing system according to the present invention includes: a mobile information terminal that receives transmission data wirelessly transmitted from a wireless transmission device installed in each area of a plurality of areas and the transmission data including position information and category information on the area in which the wireless transmission device is installed; and an information providing server that stores a first data table including a plurality of pieces of position information, a plurality of pieces of category information and a plurality of pieces of content regarding the plurality of areas and provision item information indicating merchandise or service provided in the plurality of areas and a second data table including a plurality of pieces of relevant category information respectively relevant to the plurality of pieces of category information and wirelessly communicates with the mobile information terminal. When the transmission data transmitted from the mobile information terminal is received, the information providing server extracts content corresponding to the provision item information and the category information included in the transmission data from the a plurality of pieces of content included in the first data table and transmits the extracted content to the mobile information terminal. When a switching request requesting transmission of content different from most recently received content is received from the mobile information terminal, the information providing server extracts the relevant category information relevant to the category information corresponding to the most recently received content from the second data table, extracts the content corresponding to the relevant category information from the first data table, and transmits the content corresponding to the relevant category information to the mobile information terminal.

An information providing server according to the present invention includes: a communication unit that wirelessly communicates with a mobile information terminal that receives transmission data wirelessly transmitted from a wireless transmission device installed in each area of a plurality of areas and the transmission data including position information and category information on the area in which the wireless transmission device is installed; a facility information storage unit that stores a first data table including a plurality of pieces of position information, a plurality of pieces of category information and a plurality of pieces of content regarding the plurality of areas and provision item information indicating merchandise or service provided in the plurality of areas; a relevant category information storage unit that stores a second data table including a plurality of pieces of relevant category information respectively relevant to the plurality of pieces of category information; and a control unit that extracts content corresponding to the provision item information and the category information included in the transmission data from the a plurality of pieces of content included in the first data table and makes the communication unit transmit the extracted content to the mobile information terminal when the transmission data transmitted from the mobile information terminal is received, and extracts relevant category information relevant to category information corresponding to content received most recently by the mobile information terminal from the second data table, extracts the content corresponding to the relevant category information from the first data table, and makes the communication unit transmit the content corresponding to the relevant category information to the mobile information terminal when a switching request requesting transmission of content different from the most recently received content is received from the mobile information terminal.

### Effect of the Invention

According to the present invention, beneficial content can be provided from the information providing server to a mobile information terminal carried by a user moving between areas.

### BRIEF DESCRIPTION OF THE DRAWINGS

FIG. 1 is a functional block diagram schematically showing a configuration of an information providing system according to a first embodiment of the present invention.

FIG. 2 is a plan view showing an example of arrangement of stores in a commercial facility employing the information providing system according to the first embodiment.

FIG. 3 is a diagram showing an example of a transmission data table that defines position information and category information included in transmission data transmitted from a wireless transmission device in the information providing system according to the first embodiment.

FIG. 4 is a diagram showing an example of a category information table that defines correspondence relationship between each category (category name) of stores (areas) and category information in the information providing system according to the first embodiment.

FIG. 5 is a front view showing an example of a display screen of a mobile information terminal in the information providing system according to the first embodiment.

FIG. 6 is a block diagram showing an example of hardware configuration of the mobile information terminal in the information providing system according to the first embodiment.

FIG. 7 is a diagram showing an example of a data storage table stored in a data storage unit of an information providing server in the information providing system according to the first embodiment.

FIG. 8 is a diagram showing an example of a relevant category information table stored in a relevant category information storage unit of the information providing server in the information providing system according to the first embodiment.

FIG. 9 is a diagram showing an example of a facility information table stored in a facility information storage unit of the information providing server according to the first embodiment.

FIG. 10 is a block diagram showing an example of the hardware configuration of the information providing server in the information providing system according to the first embodiment.

FIG. 11 is a flowchart showing the operation of the mobile information terminal in the information providing system according to the first embodiment.

FIGS. 12(a) to 12(f) are diagrams showing an example of display screen transition of the mobile information terminal in the information providing system according to the first embodiment.

FIGS. 13(a) to 13(f) are diagrams showing an example of display screen transition of a mobile information terminal as a comparative example.

FIG. 14 is a flowchart showing a content transmission process of the information providing server in the information providing system according to the first embodiment.

FIG. 15 is a flowchart showing an update process for the relevant category information table of the information providing server in the information providing system according to the first embodiment.

FIG. 16 is a functional block diagram schematically showing a configuration of an information providing system according to a second embodiment of the present invention.

### MODE FOR CARRYING OUT THE INVENTION

Embodiments of the present invention will be described below with reference to the accompanying drawings. In the drawings, substantially identical components are assigned the same reference characters. The embodiments are just examples of systems and devices obtained by employing the present invention, and thus a variety of modifications are possible.

### (1) First Embodiment

### (1-1) Configuration

### Information Providing System 1

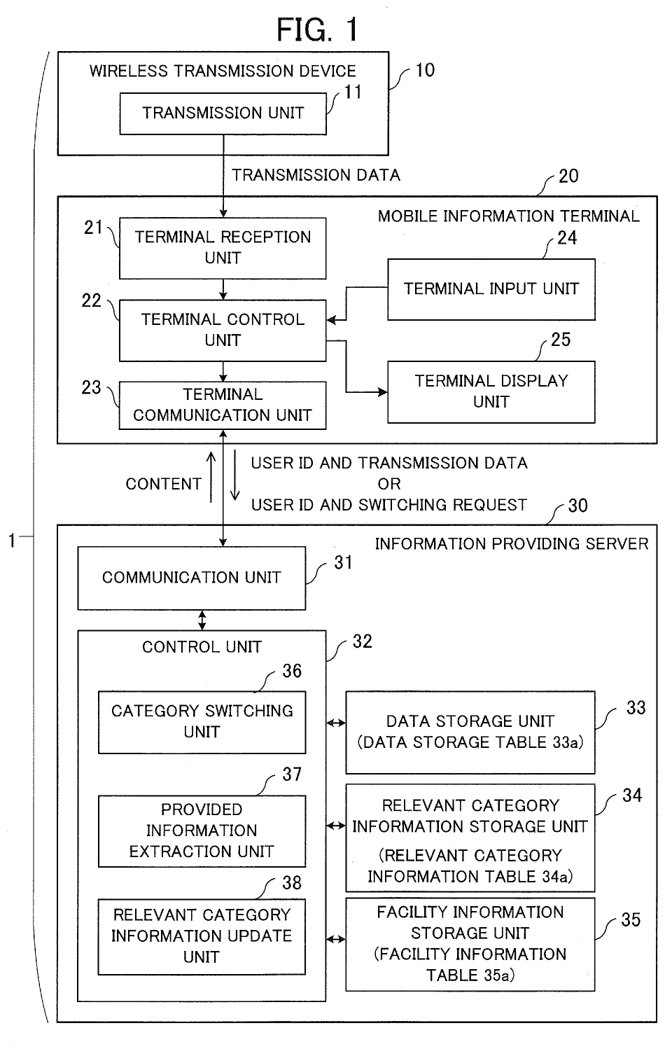

An information providing system 1 according to a first embodiment of the present invention will be described below. FIG. 1 is a functional block diagram schematically showing the configuration of the information providing system 1 according to the first embodiment of the present invention. The information providing system 1 is a system capable of executing an information providing method according to the first embodiment. In the first embodiment, the description will be given of a case where the information providing system 1 is applied to a commercial facility such as a shopping mall. As shown in FIG. 1, the information providing system 1 includes a wireless transmission device 10 installed in each of a plurality of stores (a plurality of areas) in the commercial facility and wirelessly transmitting transmission data including position information on the store and category information indicating a category of the store, a mobile information terminal 20 that receives the transmission data wirelessly transmitted from the wireless transmission device 10 and displays an image (textual information, a still image, motion video, or the like) based on content (i.e., content data) regarding the store, and an information providing server 30 that is connected to be able to wirelessly communicate with the mobile information terminal 20 and transmits the content to be displayed by the mobile information terminal 20.

When the user carrying the mobile information terminal 20 enters or approaches a store (area) in which the wireless transmission device 10 has been installed, the mobile information terminal 20 receives the transmission data wirelessly transmitted from the wireless transmission device 10. The transmission data is data including the position information on the store in which the wireless transmission device 10 has been installed and the category information on the store. The mobile information terminal 20 receiving the transmission data transmits the transmission data to the information providing server 30. By transmitting the transmission data to the information providing server 30, the mobile information terminal 20 acquires content indicating information such as guide information or event introduction information on a store in the commercial facility, or information on a usable coupon in the commercial facility, from the information providing server 30 and displays an image based on the acquired content on a terminal display unit (display) 25 of the mobile information terminal 20. While the transmission data transmitted from the mobile information terminal 20 to the information providing server 30 may be exactly the same as the transmission data received from the wireless transmission device 10, the transmission data transmitted from the mobile information terminal 20 to the information providing server 30 may also be part of the transmission data received from the wireless transmission device 10 (information based on the transmission data).

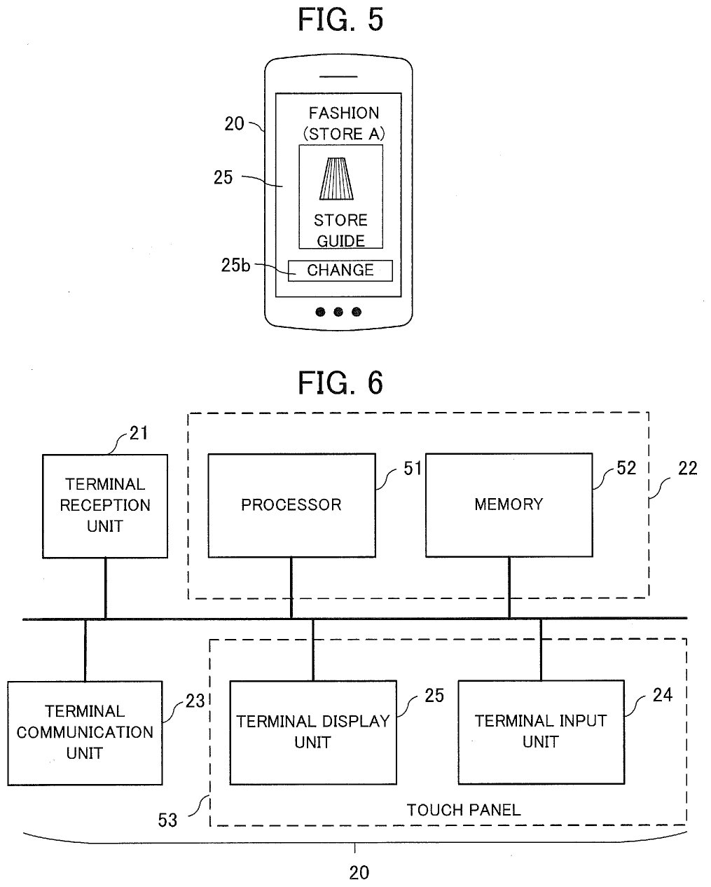

Further, when the user exited from the store and walking in a passage between areas inputs a switching request regarding the displayed content (i.e., switching command) through a terminal input unit 24 of the mobile information terminal 20 (e.g., touches a “CHANGE” button in FIG. 5 which will be explained later), the mobile information terminal 20 transmits the switching request as a command signal to the information providing server 30. The information providing server 30 receiving the switching request extracts content corresponding to other category information relevant to the category information on the store represented by the content currently displayed on the mobile information terminal 20 (i.e., most recently received content), namely, relevant category information as other category information associated with the category information on the store due to a high degree of relevance, from a relevant category information table (second data table) 34a as previously stored data, extracts the content corresponding to the extracted relevant category information from a facility information table (first data table) 35a, and transmits the extracted content to the mobile information terminal 20. The mobile information terminal 20 receives the content corresponding to the relevant category information from the information providing server 30 and displays an image based on the received content.

When no switching request is inputted, the content received most recently remains being displayed on the terminal display unit 25 of the mobile information terminal 20. When the switching request is inputted (e.g., the “CHANGE” button is touched) during the movement between areas, the information providing server 30 determines a store beneficial to the user based on the category and the position of the store in which the user stayed most recently and the relevant category information table 34a previously stored, and transmits content beneficial to the user to the mobile information terminal 20 carried by the user. Accordingly, the information providing system 1 is capable of providing the user's mobile information terminal 20 with content beneficial to the user moving between stores (areas).

### Wireless Transmission Device 10

As shown in FIG. 1, the wireless transmission device 10 includes a transmission unit 11. The wireless transmission device 10 may include a control unit (not shown) that controls the transmission unit 11 and a storage unit (not shown) that stores information. The transmission unit 11 wirelessly transmits (sends out) transmission data including the position information and the category information on a store in which the wireless transmission device 10 has been installed. The transmission data transmitted by the transmission unit 11 can be either information stored in the storage unit of the wireless transmission device 10 or information provided from a device such as a server for providing information to the wireless transmission device 10. The category information indicates, for example, a category to which merchandise handled by the store or service provided by the store belongs. The mobile information terminal 20 carried by the user entering a store or entering a predetermined area is capable of receiving the transmission data wirelessly transmitted from the transmission unit 11.

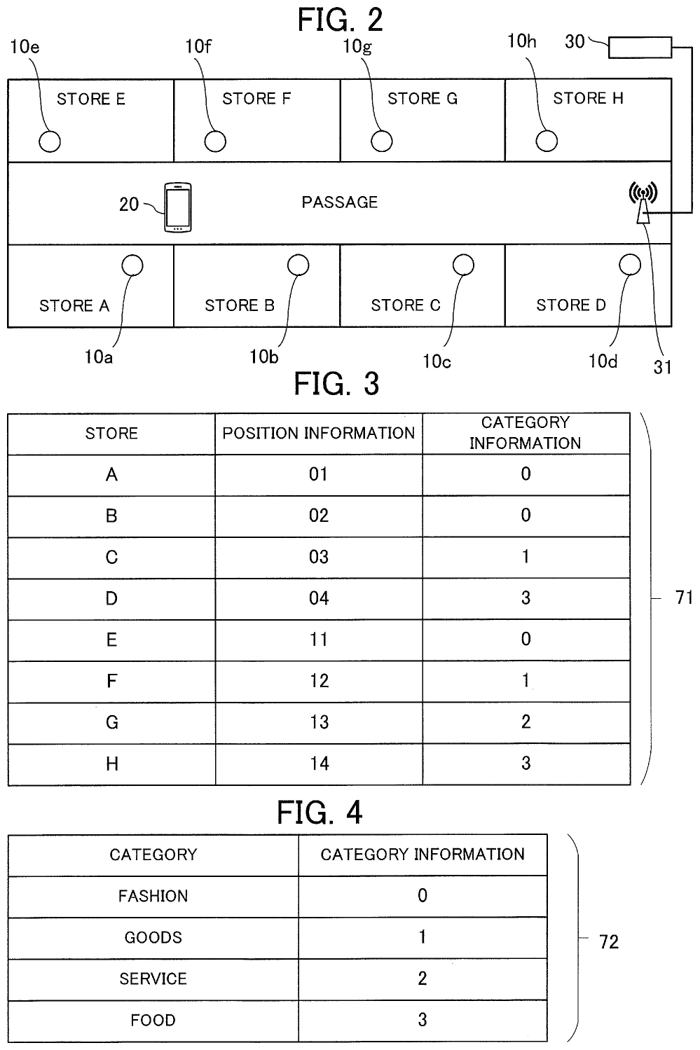

FIG. 2 is a plan view showing an example of arrangement of the plurality of stores in the commercial facility. FIG. 3 is a diagram showing an example of a transmission data table 71 that defines the position information and the category information included in the transmission data transmitted from the wireless transmission device 10 (i.e., wireless transmission device 10a-10h in FIG. 2) installed in each store A-H shown in FIG. 2. According to the transmission data table 71, the wireless transmission device 10 (10a in FIG. 2) installed in the store A transmits the transmission data in which the position information is “01” and the category information is “0”.

The position information is information for identifying each of the plurality of stores A to H in the commercial facility. For example, as shown in the transmission data table 71, the position information is information unique to each of the plurality of stores A to H (e.g., unique numerical value), such as the position information “01” on the store A and the position information “02” on the store B.

The category information is information indicating classification of merchandise sold or service provided by each of the plurality of stores in the commercial facility, for example. The category information can be defined by information allowing identification of a category (e.g., numerical value). FIG. 4 is a diagram showing an example of a category information table 72 that defines correspondence relationship between each category (category name) and category information (unique information). In the category information table 72, the category information on stores whose category is “fashion” is “0”, and the category information on stores whose category is “goods” is “1”, for example. The stores whose category is “fashion” are, for example, stores selling merchandise related to fashion such as clothes, shoes or bags. The stores whose category is “goods” are, for example, stores selling merchandise related to general goods such as interior goods or groceries.

While the position information and the category information are generally represented by numerical values as shown in FIG. 3 and FIG. 4, the position information will be represented by A-H as the corresponding “store name” and the category information will be represented by the corresponding “category name” in the following description in order to facilitate the understanding.

The wireless transmission device 10 transmits the transmission data by means of short-range wireless communication. As the standard for short-range wireless communication, there is BLE as Bluetooth 4.0 (registered trademark), for example. In BLE, the 2.4 GHz band is used and the communication range can be set in a relatively narrow range of 2.5 m to 50 m. Therefore, a receivable range of the transmission data transmitted from the wireless transmission device 10 can be set as a limited region by adjusting the intensity of radio waves transmitted by the wireless transmission device 10.

The transmission data transmitted by means of BLE is transmitted and received by using a Universally Unique Identifier (UUID: character string 128 bits long), a Major value (integer 16 bits long), and a Minor value (integer 16 bits long). The UUID is generally set at a value unique to each wireless transmission device 10 in many cases, and in the first embodiment, the information stored in the UUID can be regarded as the position information. To the Major value and the Minor value, values can be set arbitrary as data regions. Thus, the category information can be stored by using the region of the Major value or the Minor value. Further, the transmission data is transmitted from the wireless transmission device 10 repeatedly, e.g., periodically at predetermined intervals. In the BLE standard, the transmission interval is set between 20 ms (milliseconds) and 10.24 s (seconds). In the first embodiment, the wireless transmission device 10 is assumed to transmit the transmission data at 100 ms intervals; however, the transmission interval may be set at a value other than 100 ms as long as the interval is within the range stipulated in the BLE standard.

### Mobile Information Terminal 20

As shown in FIG. 1, the mobile information terminal 20 includes a terminal reception unit 21 that receives the transmission data wirelessly transmitted from the wireless transmission device 10, a terminal control unit 22 that controls the whole of the mobile information terminal 20, a terminal communication unit 23 that performs wireless communication with the information providing server 30, a terminal input unit 24 that receives user inputs, and a terminal display unit 25 as a display for displaying images. While the terminal input unit 24 and the terminal display unit 25 can be components different from each other, the terminal input unit 24 and the terminal display unit 25 can also be implemented as an integrated component such as a touch panel.

The terminal reception unit 21 receives the transmission data transmitted from the wireless transmission device 10 and sends the received transmission data to the terminal control unit 22. The terminal reception unit 21 is capable of performing the reception in conformity with the standard of Bluetooth 4.0 (registered trademark), for example. The mobile information terminal 20 is a communication device capable of performing short-range wireless communication by use of the terminal reception unit 21. Specific examples include a smartphone, a tablet terminal, a cellular phone, a personal computer (PC), and so forth.

Besides the function of receiving the transmission data, the terminal reception unit 21 may have a function of acquiring (detecting) the intensity of the received radio wave at the time of receiving the transmission data. The intensity of the received radio wave at the time when the terminal reception unit 21 receives the transmission data becomes higher with the decrease in the distance between the position of the mobile information terminal 20 and the position of the wireless transmission device 10. To make use of such a characteristic, the intensity of the received radio wave when the mobile information terminal 20 receives the transmission data in the store is previously measured, and a reference value of the intensity of the received radio wave when the user carrying the mobile information terminal 20 can be judged to be situated in the store is previously stored in a storage unit (not shown) of the mobile information terminal 20. The terminal reception unit 21 can be set so as to send the received transmission data to the terminal control unit 22 when the intensity of the received radio wave when the transmission data is received from the wireless transmission device 10 is over the previously set reference value, and not to send the received transmission data to the terminal control unit 22 when the intensity of the received radio wave is less than or equal to the reference value.

The terminal input unit 24 is an input interface of the mobile information terminal 20, such as a user operation unit like an operation button or a touch panel, for example. When the switching request as information indicating a request (command) for switching the content displayed on the terminal display unit 25 of the mobile information terminal 20 is inputted to the terminal input unit 24 by the user, the switching request is sent from the terminal input unit 24 to the terminal control unit 22. In a case where the mobile information terminal 20 is a smartphone, for example, the terminal control unit 22 acquires the switching request through a user operation on a touch panel used as the terminal input unit 24. The user operation on the touch panel can be, for example, touching as the operation of touching a prescribed position on the screen of the touch panel with a finger, swiping as the operation of sliding a finger in a predetermined direction on the screen of the touch panel, or the like.

The content displayed on the terminal display unit 25 of the mobile information terminal 20 is, for example, image data indicating introduction information regarding a store in the commercial facility, event information regarding a limited-time sale or the like in the commercial facility, information regarding a coupon usable in a store in the commercial facility, or the like. The format of the displayed content can be a still image, motion video, or a combination thereof.

The terminal communication unit 23 wirelessly connects to the information providing server 30 storing content such as information on a store in the commercial facility. The terminal control unit 22 transmits the user ID (identification information) and the transmission data, or the user ID and the switching request, to the information providing server 30 via the terminal communication unit 23. The user ID is, for example, a unique character string (e.g., unique value), such as “U01” or “U02”, assigned to each user carrying the mobile information terminal 20. The user ID is previously acquired by the mobile information terminal 20 from a server managing the user ID via a network, for example. The terminal control unit 22 acquires content based on the user ID and the transmission data, or the user ID and the switching request, from the information providing server 30 via the terminal communication unit 23 and sends the acquired content to the terminal display unit 25.

The communication between the terminal communication unit 23 and the information providing server 30 can be performed according to a prescribed wireless communication standard such as Wireless Fidelity (Wifi: registered trademark). For example, in a case where an access point (31 in FIG. 2) connectable to the mobile information terminal 20 has been provided at a certain spot in the commercial facility, the mobile information terminal 20 can connect to the information providing server 30 by connection with the access point.

The terminal display unit 25 displays the content acquired by the terminal control unit 22. FIG. 5 is a front view showing an example of a display screen of the terminal display unit 25 of the mobile information terminal 20. In FIG. 5, a store guide about the store A belonging to the category “fashion” is displayed on the terminal display unit 25 of the mobile information terminal 20. When the CHANGE button 25b as a switching button displayed on the terminal display unit 25 of the mobile information terminal 20 is touched, the switching request is acquired by the terminal input unit 24 and information on a store belonging to a category other than “fashion”, such as “goods” or “food”, is displayed on the terminal display unit 25 of the mobile information terminal 20 in FIG. 5.

When the terminal reception unit 21 of the mobile information terminal 20 receives new transmission data transmitted from the wireless transmission device 10 or the switching request for switching the content displayed on the terminal display unit 25 of the mobile information terminal 20 is inputted through the terminal input unit 24, the terminal control unit 22 acquires new content from the information providing server 30 via the terminal communication unit 23 and switches the display image on the terminal display unit 25 to an image based on the new content.

FIG. 6 is a block diagram showing an example of hardware configuration of the mobile information terminal 20 in the information providing system 1 according to the first embodiment. As shown in FIG. 6, the terminal control unit 22 of the mobile information terminal 20 in the first embodiment can be implemented by using a memory 52 as a storage device for storing a program as software and a processor 51 as an information processing unit for executing the program stored in the memory 52. Incidentally, it is also possible to implement part of the terminal control unit 22, the terminal reception unit 21, the terminal communication unit 23, the terminal input unit 24 and the terminal display unit 25 shown in FIG. 1 by using the memory 52 shown in FIG. 6 and the processor 51 for executing a program. Further, in the example of FIG. 6, the terminal display unit 25 and the terminal input unit 24 constitute a touch panel 53.

### Information Providing Server 30

As shown in FIG. 1, the information providing server 30 includes a communication unit 31 that performs wireless communication with the mobile information terminal 20, a control unit 32 that controls the whole of the information providing server 30, a data storage unit 33, a relevant category information storage unit 34, and a facility information storage unit 35. The control unit 32 includes a category switching unit 36, a provided information extraction unit 37 and a relevant category information update unit 38. While the data storage unit 33, the relevant category information storage unit 34 and the facility information storage unit 35 can be storage devices (hard disk drive, semiconductor memory, etc.) separate from each other, the storage units 33, 34 and 35 can also be different storage areas of one storage device.

The communication unit 31 is wirelessly connected to the mobile information terminal 20 by Wifi or the like via an access point, for example. The communication unit 31 receives the user ID and the transmission data, or the user ID and the switching request, from the mobile information terminal 20 and sends the received information to the control unit 32. The category switching unit 36 of the control unit 32 stores an acquisition time of the acquired transmission data, the transmission data, and the user ID in the data storage unit 33. In this case, when the control unit 32 acquires the switching request from the mobile information terminal 20, the control unit 32 sends the user ID and the switching request also to the relevant category information update unit 38. The acquisition time of the transmission data can be acquired from a clock or the like installed in the control unit 32, for example, or can be acquired from the transmission data in a case where time information is included in the transmission data. Further, the communication unit 31 transmits the content acquired from the facility information storage unit 35 by the provided information extraction unit 37 to the mobile information terminal 20 via the communication unit 31.

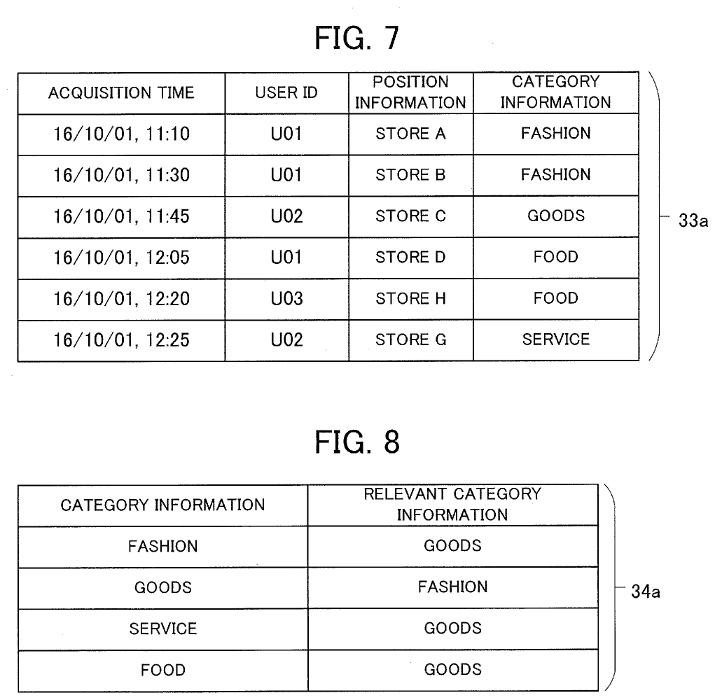

The data storage unit 33 stores the time when the communication unit 31 acquires the transmission data, the user ID, and the position information and the category information included in the transmission data, for example. FIG. 7 is a diagram showing an example of a data storage table (third data table) 33a stored in the data storage unit 33. The data storage table 33a stores user IDs, position information on stores, and category information on stores in the order of acquisition of the transmission data by the communication unit 31. The format of the acquisition time in the data storage table 33a is “year (last two digits of the year of the Christian Era)/month/day, hour:minute”, for example.

The relevant category information storage unit 34 stores the category information and the relevant category information. The relevant category information is category information indicating another category having a high degree of relevance to the category represented by the category information. For example, the relevant category information on the category information “fashion” is “goods”. In this case, it means that the category information “fashion” has a high degree of relevance to the category information “goods”.

FIG. 8 is a diagram showing an example of the relevant category information table 34a stored in the relevant category information storage unit 34 of the information providing server 30 in the information providing system 1 according to the first embodiment. The relevant category information storage unit 34 has previously stored the relevant category information table 34a defining correspondence relationship between category information and relevant category information having a high degree of relevance to the category information according to a certain rule.

The definition of the relevant category information table 34a in FIG. 8 will be explained concretely below with reference to FIG. 2 and FIG. 3. In this example, the relevant category information in the relevant category information table 34a is defined based on positional relationship between stores (e.g., adjoining or facing, as an example of being at very close positions) and a ratio of stores (e.g., the number of adjoining or facing stores in regard to each category). For example, stores whose category information is “fashion” are the store A, the store B and the store E. The store E adjoins the store F whose category information is “goods”. The store B adjoins the store C whose category information is “goods” and faces the store F whose category information is “goods”. Since stores whose category information is “fashion” are situated to adjoin or face (i.e., situated at positions very close to) a store whose category information is “goods” as above, the relevant category information on the category information “fashion” is defined as “goods”.

Further, stores whose category information is “food” are the store D and the store H. The store D adjoins the store C whose category information is “goods”, and the store H adjoins the store G whose category information is “service”. In this case, in the areas shown in FIG. 2, there are store C and store F as stores whose category information is “goods”, while there is only one store G as a store whose category information is “service”, and thus the number of stores whose category information is “goods” is greater than the number of stores whose category information is “service”. Accordingly, the relevant category information on the category information “food” is defined as “goods”.

While the relevant category information in the relevant category information table 34a was defined based on the positional relationship between stores and the number of stores, the determination method for defining the relevant category information relevant to the category information can be a determination method based on a different rule as long as the determination method is based on a certain rule.

Further, the relevant category information table 34a may exist in the relevant category information storage unit 34 as a table for each floor of the commercial facility, for example, and the relevant category information table 34a used in the relevant category information storage unit 34 may be switched according to the present position of the user carrying the mobile information terminal 20.

Furthermore, the relevant category information table 34a may also exist individually for each user carrying a mobile information terminal 20 and the relevant category information table 34a used in the relevant category information storage unit 34 may be switched according to the user ID.

The relevant category information update unit 38 acquires the user ID and the switching request from the communication unit 31, acquires the category information from the facility information storage unit 35, and updates the relevant category information table 34a stored in the relevant category information storage unit 34 based on the acquired information. When a new user ID is acquired from the communication unit 31, the relevant category information update unit 38 generates the relevant category information table 34a corresponding to the new user ID in the relevant category information storage unit 34.

The relevant category information update unit 38 refers to the facility information storage unit 35 periodically, for example, and updates the relevant category information table 34a when it reaches a time already set in the facility information storage unit 35. The cycle at which the relevant category information update unit 38 refers to the facility information storage unit 35 is set at one hour, for example; however, the cycle is alterable.

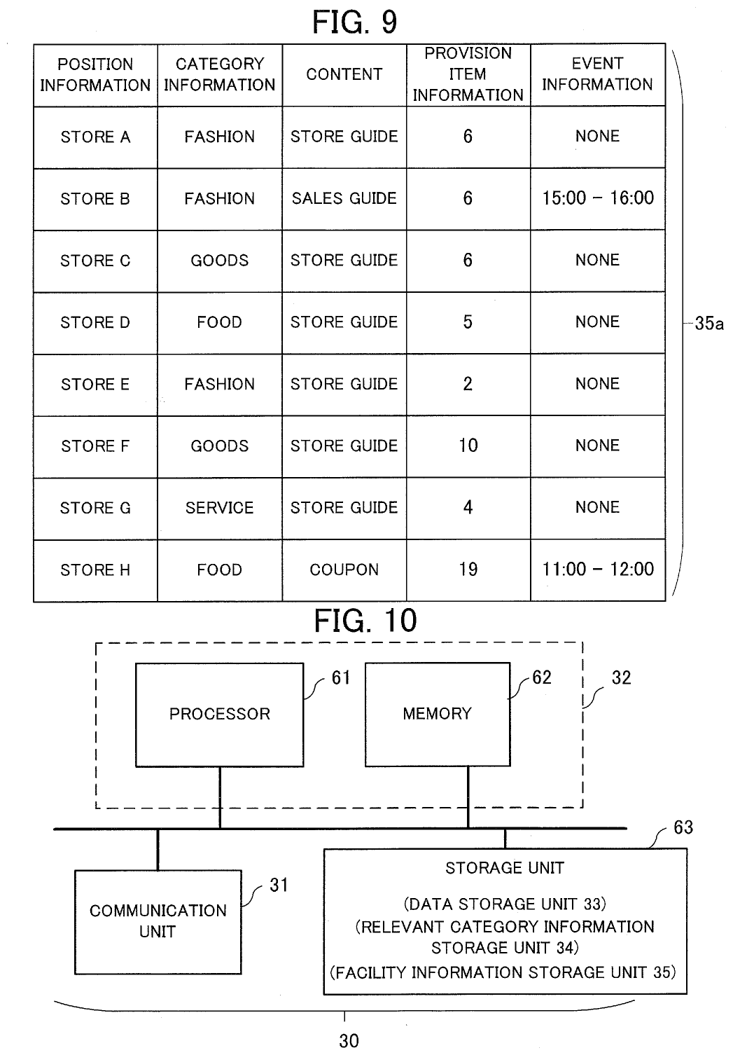

FIG. 9 is a diagram showing an example of the facility information table 35a stored in the facility information storage unit 35. As shown in FIG. 9, the facility information table 35a corresponds to the stores A to H shown in FIG. 3. In the facility information table 35a, for example, the following information are set: store position information, store category information, content of each store, provision information, content of each store, provision item information that indicates a characteristic of merchandise or service provided by each store by digitizing the characteristic (provision item information indicating merchandise or service provided by each area, namely, merchandise/service information), and event information including a starting time and an ending time of an event held by each store in the commercial facility. From the starting time to the ending time of an event set in the event information in the facility information table 35a, the relevant category information update unit 38 updates the relevant category information in the relevant category information table 34a to the category information to which the store holding the event belongs. Specifically, the facility information table 35a indicates that the store H whose category information is “food” holds an event from 11 o'clock to 12 o'clock. Thus, when it reaches 11 o'clock, the relevant category information update unit 38 acquires the category information “food” on the store H from the facility information storage unit 35 and updates the relevant category information corresponding to the category information “fashion”, “goods” and “service” in the relevant category information table 34a to the category information “food” acquired from the facility information storage unit 35. Incidentally, the provision item information indicating merchandise or service provided by a store includes provision item information in a case where the store provides merchandise only, provision item information in a case where the store provides service only, and provision item information in a case where the store provides both merchandise and service.

After 12 o'clock when the event held by the store H ends, the relevant category information update unit 38 returns the relevant category information tables 34a respectively corresponding to all user IDs to the state before the update. Even at a time before the end of the event by the store H, when the switching request is acquired more than once from the communication unit 31, the relevant category information update unit 38 returns the relevant category information table 34a corresponding to the user ID acquired by the relevant category information update unit 38 together with the switching request to the initial state. The acquirement of the switching request by the relevant category information update unit 38 more than once from the communication unit 31 means that the user carrying the mobile information terminal 20 acquired the coupon once as the content of the store H and is thereafter requesting acquisition of content corresponding to category information other than “food” in the time period in which the event is held by the store H.

The content of a store whose event information has been set in the facility information table 35a is transmitted from the information providing server 30 only in the time period in which the event is held by the store. For example, in the case of the store H in the facility information table 35a, a coupon is distributed from the information providing server 30 to the mobile information terminal 20 from 11 o'clock to 12 o'clock.

When no switching request is sent from the communication unit 31 to the category switching unit 36, the category switching unit 36 sends the position information and the category information to the provided information extraction unit 37. When the switching request is sent from the communication unit 31 to the category switching unit 36, the category switching unit 36 acquires the latest position information and category information corresponding to the user ID from the data storage unit 33. Then, the category switching unit 36 acquires the relevant category information corresponding to the category information acquired from the data storage unit 33 from the relevant category information table 34a stored in the relevant category information storage unit 34 and corresponding to the user ID. Then, the category switching unit 36 sends the position information and the relevant category information to the provided information extraction unit 37.

During the update of the relevant category information table 34a in the relevant category information storage unit 34 by the relevant category information update unit 38, the category switching unit 36 does not acquire the relevant category information from the relevant category information storage unit 34 until the update of the relevant category information table 34a by the relevant category information update unit 38 ends.

The provided information extraction unit 37 extracts content to be delivered to the mobile information terminal 20 from the facility information storage unit 35 based on the position information and the category information, or the position information and the relevant category information, acquired from the category switching unit 36 and sends the extracted content to the communication unit 31.

For example, when the provided information extraction unit 37 acquires the position information “store B” and the category information “fashion”, the provided information extraction unit 37 extracts the content “store guide” of the “store A” or the “store E” as the content of a store belonging to the same category as the “store B” from the facility information table 35a stored in the facility information storage unit 35.

In this case, the provided information extraction unit 37 further compares the provision item information corresponding to the store B in the facility information table 35a stored in the facility information storage unit 35 with each of the provision item information corresponding to the store A and the provision item information corresponding to the store E, and determines the content of a store whose numerical value of the provision item information is the same or whose difference in the numerical value of the provision item information is small as the content to be provided to the mobile information terminal 20. In the facility information table 35a shown in FIG. 9, the provision item information corresponding to the store B is “6”, the provision item information corresponding to the store E is “2”, and the difference between these pieces of provision item information is “4”. In contrast, the provision item information corresponding to the store B is “6” and the numerical value is the same as that of the provision item information corresponding to the store A (namely, the difference is “0”). In this case, the provided information extraction unit 37 extracts the content of the store A.

To sum up, when the provided information extraction unit 37 determines the content to be provided based on the position information and the category information without using the provision item information, the content “store guide” of the “store A” or the “store E” as the content of a store belonging to the same category as the store B is extracted from the facility information table 35a stored in the facility information storage unit 35. In contrast, when the provided information extraction unit 37 determines the content to be provided by using the provision item information in addition to the position information and the category information, the content of the store A is extracted as described above.

When the provided information extraction unit 37 acquires “store B” as the position information and “fashion” as the relevant category information, the provided information extraction unit 37 extracts the content “store guide” of the “store A” as the content of a store belonging to the same category as the store B from the facility information table 35a stored in the facility information storage unit 35. In this case, the provided information extraction unit 37 searching the facility information table 35a for a corresponding store performs the search downward in the facility information table 35a from the first stage of the facility information table 35a, for example.

The facility information storage unit 35 stores the facility information table 35a storing the position information, the category information, the content, the provision item information and the event information regarding each store in the commercial facility. The content and the event information stored in the facility information table 35a can be properly updated by a manager of the commercial facility, a manager of a store, or the like.

The provision item information stored in the facility information table 35a is information digitized based on the merchandise or service provided by each store A-H. For example, when a certain store provides clothes, shoes and bags as merchandise, the provision item information indicating the characteristic of the merchandise or service provided by the store by using a numerical value (i.e., the provision item information corresponding to the store) may be represented by, for example, the sum total “6” of the provision item information “1” indicating clothes, the provision item information “2” indicating bags and the provision item information “3” indicating shoes. Namely, the provision item information may be calculated according to the following expression:

1(clothes)+2(bags)+3(shoes) =6(provision item information corresponding to the store)

However, this is just an example of the method of determining (calculating) the provision item information; the method of determining the provision item information can be a different method as long as the method has certain regularity. Further, more subdivided items of information, such as the type, size or capacity of the merchandise, an age range, gender, etc. as the target of sales, or an age range, gender, etc. as the target of selling the service, may be used as information referred to for the digitization of the provision item information.

FIG. 10 is a block diagram showing an example of the hardware configuration of the information providing server 30 in the information providing system 1 according to the first embodiment. As shown in FIG. 10, in the information providing server 30 in the first embodiment, the control unit 32 can be implemented by using a memory 62 as a storage device storing a program as software and a processor 61 as an information processing unit that executes the program stored in the memory 62. Incidentally, it is also possible to implement part of the control unit 32 shown in FIG. 1 by the memory 62 shown in FIG. 10 and the processor 61 executing a program.

### (1-2) Operation

Next, the operation of the information providing system 1 according to the first embodiment will be described below.

### Operation of Wireless Transmission Device 10

First, the transmission unit 11 of the wireless transmission device 10 installed in each of the plurality of stores in the commercial facility transmits the transmission data including the position information and the category information every 100 ms, for example. In this case, the radio wave intensity has been set so that the mobile information terminal 20 can receive the transmission data in the store in which the wireless transmission device 10 has been installed and the mobile information terminal 20 cannot receive the transmission data outside the store.

### Operation of Mobile Information Terminal 20

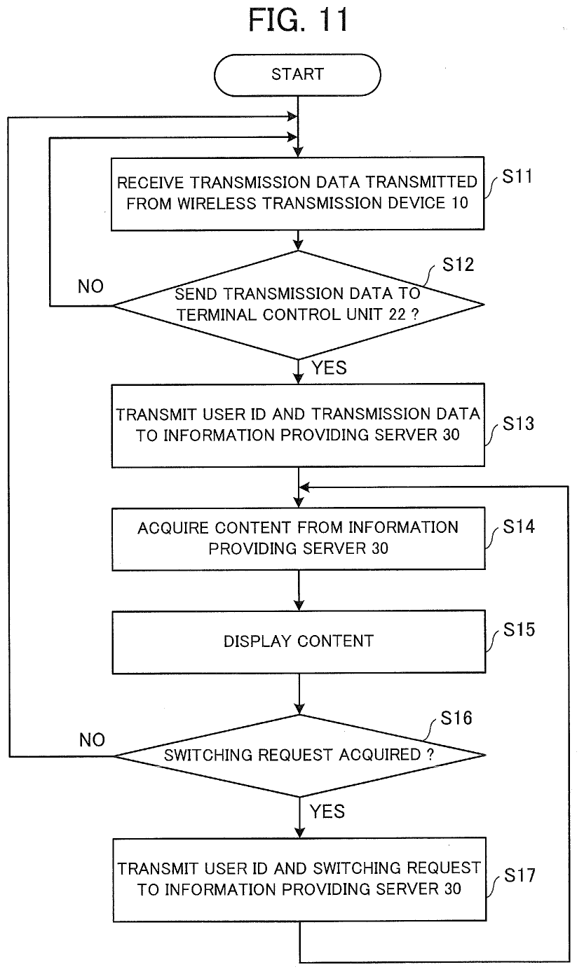

The mobile information terminal 20 receives the transmission data transmitted from the wireless transmission device 10 and displays content such as a store guide on the terminal display unit 25 based on the received transmission data, an input operation on the terminal input unit 24 by the user carrying the mobile information terminal 20, or the like. Here, a process of the display of content in the mobile information terminal 20 will be described. FIG. 11 is a flowchart showing the process of the display of content in the mobile information terminal 20.

When the user carrying the mobile information terminal 20 enters a store in which the wireless transmission device 10 has been installed, the terminal reception unit 21 of the mobile information terminal 20 starts receiving the transmission data transmitted from the wireless transmission device 10 (step S11).

Subsequently, the terminal reception unit 21 judges whether or not the transmission data received from the wireless transmission device 10 should be sent to the terminal control unit 22 (step S12). When the terminal reception unit 21 received transmission data including the same position information and category information as transmission data received last time (received most recently) or the reception radio wave intensity at the time of acquiring the transmission data is lower than the reference value, the terminal reception unit 21 does not send the transmission data to the terminal control unit 22 and retries the reception of the transmission data (step S11). Incidentally, the judgment processing of the steps S11 and S12 may be executed by the terminal control unit 22.

When the transmission data received from the wireless transmission device 10 is not transmission data including the same position information and category information as the transmission data received last time and the reception radio wave intensity at the time of acquiring the transmission data is higher than or equal to the reference value, the terminal reception unit 21 advances the process to the next step S13.

Subsequently, the terminal control unit 22 transmits the user ID and the transmission data to the information providing server 30 via the terminal communication unit 23 (step S13). Here, it is assumed that the user made network connection or the like to a server managing user IDs in the commercial facility or outside the commercial facility and the mobile information terminal 20 carried by the user has previously acquired the user ID. Further, the user makes the mobile information terminal 20 connect to the information providing server 30 by using a Wifi access point in the commercial facility and perform communication of various types of data including the transmission data, the user ID and the content such as store information.

Subsequently, the terminal control unit 22 acquires content based on the user ID and the transmission data from the information providing server 30 via the terminal communication unit 23 (step S14). Subsequently, the terminal control unit 22 makes the terminal display unit 25 display the acquired content (step S15).

After displaying the content on the terminal display unit 25, the terminal control unit 22 judges whether or not the switching request regarding the switching of the displayed content is acquired by the terminal input unit 24 due to the user's operation on the mobile information terminal 20 (step S16). When no switching request is acquired by the terminal input unit 24 (NO in the step S16), the terminal reception unit 21 retries the reception of the transmission data. When the switching request is acquired by the terminal input unit 24 (YES in the step S16), the terminal control unit 22 transmits the user ID and the switching request to the information providing server 30 via the terminal communication unit 23 and acquires new content related to the relevant category information from the information providing server 30 (step S17).

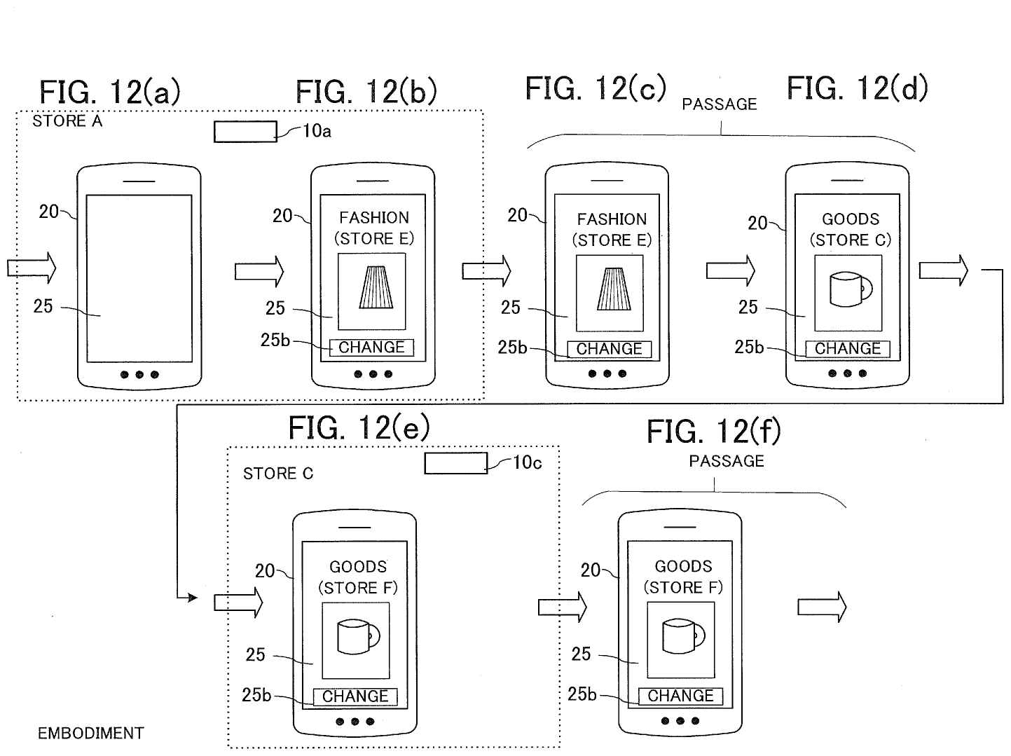

FIGS. 12(a) to 12(f) are diagrams showing an example of screen transition of the terminal display unit 25 of the mobile information terminal 20 due to movement of the user and an operation by the user. When the user carrying the mobile information terminal 20 in a display condition of FIG. 12(a) enters the store A, the mobile information terminal 20 receives the transmission data transmitted from the wireless transmission device 10a. Then, the mobile information terminal 20 transmits the user ID and the transmission data to the information providing server 30, thereby acquires the content of the store E as a store belonging to the same category as the store A and being different from the store A from the information providing server 30, and displays an image based on the content of the store E on the terminal display unit 25 like the display screen of the terminal display unit 25 of the mobile information terminal 20 in FIG. 12(b). Here, even when the user exits from the store A, the content displayed on the mobile information terminal 20 in the store A remains being displayed without change as shown in the mobile information terminal 20 in FIG. 12(c).

When the user touches the CHANGE button 25b as the terminal input unit 24 in the condition of the mobile information terminal 20 in FIG. 12(c), the terminal control unit 22 acquires the switching request. Then, the mobile information terminal 20 acquires the content of the store C belonging to the category “goods”, for example, different from the category to which the store displayed on the terminal display unit 25 belongs, from the information providing server 30 and displays the content of the store C on the terminal display unit 25 as shown in FIG. 12(d). Here, the content displayed on the mobile information terminal 20 is information on a store belonging to a category relevant to the category to which the store the user entered belongs, and the relevancy among the categories has been specified in the relevant category information storage unit 34 of the information providing server 30.

When the user enters the store C with the mobile information terminal 20 in the condition of FIG. 12(d), the mobile information terminal 20 receives the transmission data transmitted from the wireless transmission device 10c. Then, the mobile information terminal 20 transmits the user ID and the transmission data to the information providing server 30 and thereby acquires the content of the store F as a store belonging to the same category as the store C and being different from the store C from the information providing server 30 as shown in the display screen of the terminal display unit 25 in FIG. 12(e). Here, even when the user exits from the store C, the content displayed on the terminal display unit 25 in the store C remains being displayed without change as shown in the mobile information terminal 20 in FIG. 12(f).

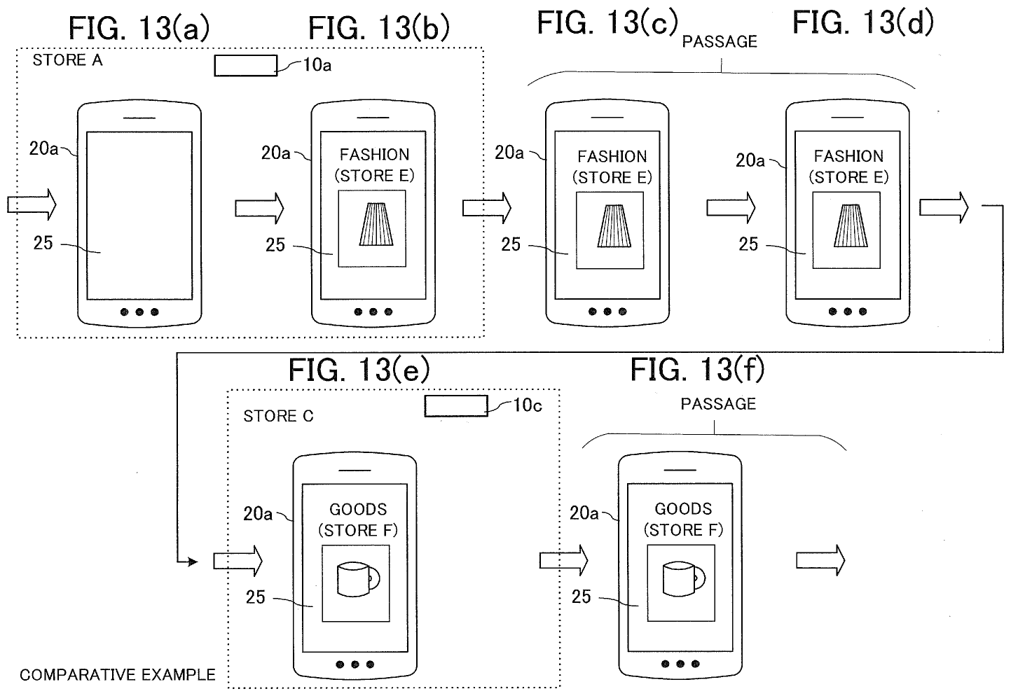

FIGS. 13(a) to 13(f) are diagrams showing an example of screen transition of the terminal display unit 25 of a mobile information terminal 20a as a comparative example due to movement of the user and an operation by the user. The mobile information terminal 20a as the comparative example is assumed to have the same configuration as the mobile information terminal 20 in the first embodiment except for lacking the switching request function. When the user carrying the mobile information terminal 20a in a display condition of FIG. 13(a) enters the store A, the mobile information terminal 20a receives the transmission data transmitted from the wireless transmission device 10a. Then, the mobile information terminal 20a transmits the user ID and the transmission data to the information providing server 30 and thereby acquires the content of the store E as a store belonging to the same category as the store A and being different from the store A from the information providing server 30 like the display screen of the mobile information terminal 20a in FIG. 13(b). Here, even when the user exits from the store A, the content displayed on the mobile information terminal 20 in the store A remains being displayed without change as shown in the terminal display unit 25 of the mobile information terminal 20a in FIGS. 13(c) and 13(d).

When the user enters the store C with the mobile information terminal 20a in the condition of FIG. 13(d), the mobile information terminal 20a receives the transmission data transmitted from the wireless transmission device 10c. Then, the mobile information terminal 20a transmits the user ID and the transmission data to the information providing server 30 and thereby acquires the content of the store F as a store belonging to the same category as the store C and being different from the store C from the information providing server 30 as shown in the display screen of the terminal display unit 25 of the mobile information terminal 20a in FIG. 13(e). Here, even when the user exits from the store C, the content displayed on the mobile information terminal 20a in the store C remains being displayed without change as shown in the mobile information terminal 20a in FIG. 13(f).

As is clear from FIG. 12(d), the mobile information terminal 20 in the first embodiment is capable of transmitting the switching request to the information providing server 30 and thereby acquiring content based on the relevant category information from the information providing server 30 and displaying the content beneficial to the user on the terminal display unit 25. In contrast, as is clear from FIG. 13(d), the mobile information terminal 20a as the comparative example continues displaying the content of the same category, and thus there are cases where content beneficial to the user cannot be displayed. As above, in the first embodiment, beneficial content can be provided to the mobile information terminal 20 carried by the user moving between stores.

### Operation of Information Providing Server 30

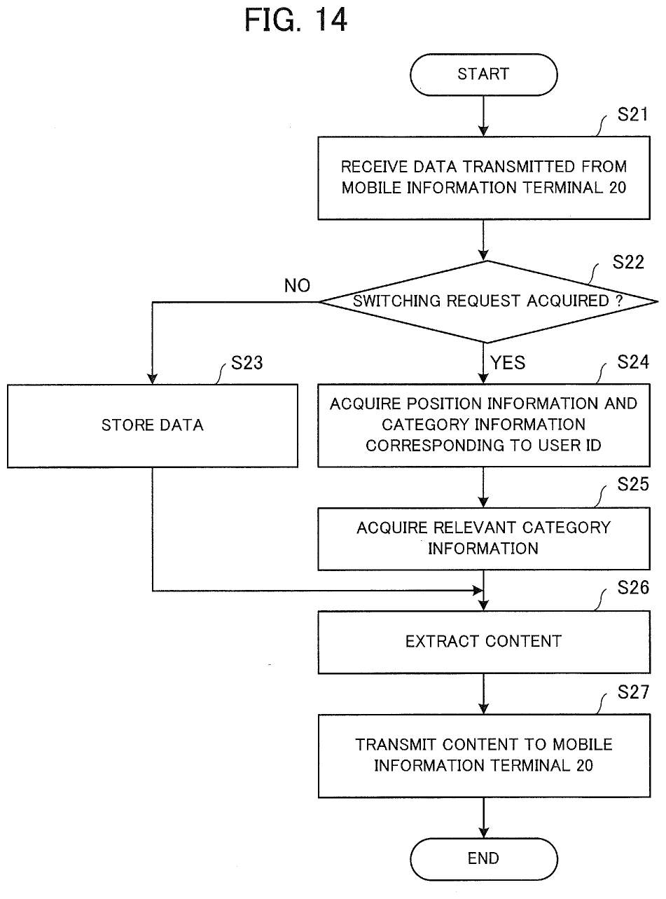

Next, a content transmission process and an update, process of relevant category information in the information providing server 30 will be described below. FIG. 14 is a flowchart showing the content transmission process in the information providing server 30.

The information providing server 30 transmits content regarding a store in the commercial facility to the mobile information terminal 20 according to the user ID and the transmission data, or the user ID and the switching request, received from the mobile information terminal 20.

First, in the information providing server 30, the communication unit 31 acquires the user ID and the transmission data or the user ID and the switching request from the mobile information terminal 20 and sends the acquisition time of the transmission data, the transmission data, and the user ID to the category switching unit 36 of the control unit 32 (step S21).

Subsequently, the category switching unit 36 of the control unit 32 judges whether or not the switching request is acquired by the communication unit 31 (step S22). When no switching request is acquired by the communication unit 31 (NO in the step S22), the category switching unit 36 of the control unit 32 stores the acquisition time of the transmission data, the user ID, the position information and the category information in the data storage unit 33 (step S23).

When the switching request is acquired by the communication unit 31 (YES in the step S22), the category switching unit 36 of the control unit 32 acquires the latest position information and category information corresponding to the user ID acquired from the communication unit 31 from the data storage table 33a stored in the data storage unit 33 (step S24).

Subsequently, the category switching unit 36 of the control unit 32 acquires the relevant category information corresponding to the category information from the relevant category information storage unit 34 (step S25). For example, when the communication unit 31 acquires the switching request and the user ID “U01” from the mobile information terminal 20 and the acquisition time is “2016/10/01, 11:50”, the category switching unit 36 acquires the position information “store B” and the category information “fashion” from the data storage table 33a of the data storage unit 33 and acquires the relevant category information “goods” corresponding to the category information “fashion” from the relevant category information table 34a of the relevant category information storage unit 34.

Subsequently, the provided information extraction unit 37 of the control unit 32 acquires content corresponding to the position information and the category information, or the position information and the relevant category information, acquired from the category switching unit 36 from the facility information storage unit 35 (step S26).

Subsequently, the control unit 32 makes the communication unit 31 transmit the content extracted in the step S26 to the mobile information terminal 20 (step S27).

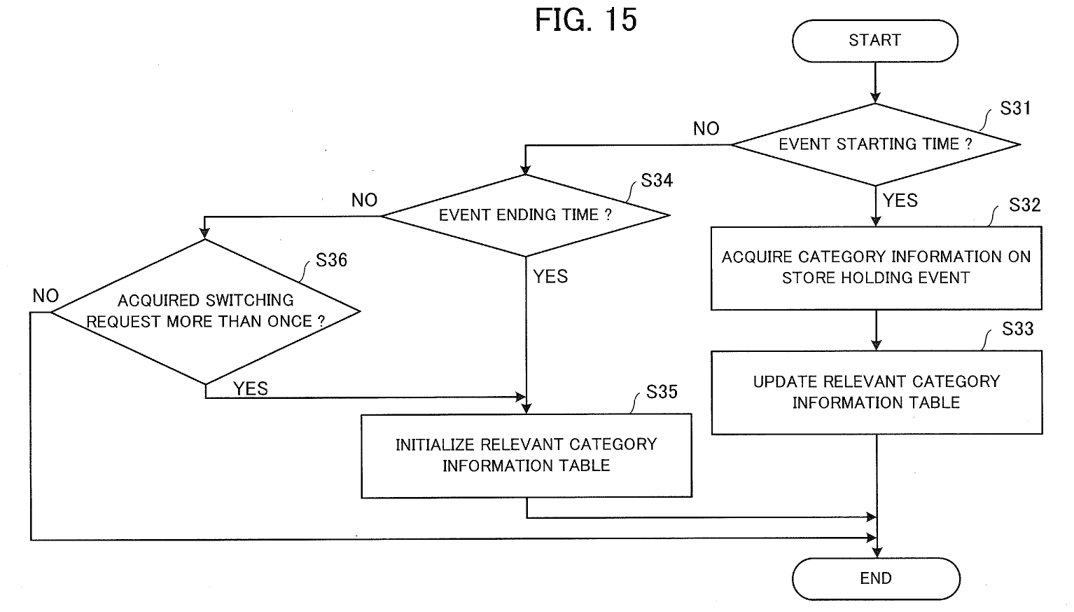

The relevant category information acquired by the category switching unit 36 from the relevant category information storage unit 34 in the step S25 is updated by the relevant category information update unit 38 of the control unit 32 depending on the situation such as the condition of an event held by a store in the commercial facility. FIG. 15 is a flowchart showing the update process of relevant category information in the information providing server 30.

The relevant category information update unit 38 judges whether or not the present time equals the event starting time of any store stored in the facility information table 35a of the facility information storage unit 35 (step S31). This judgment is made periodically by the relevant category information update unit 38 at periods of 30 minutes or 1 hour, for example. When the present time equals the event starting time of a certain store (or within a prescribed range with reference to the event starting time, or between the event starting time and the ending time) (YES in the step S31), the relevant category information update unit 38 acquires the category information on the store holding the event from the facility information storage unit 35 (step S32).

Subsequently, the relevant category information update unit 38 updates the relevant category information stored in the relevant category information storage unit 34 to the category information acquired in the step S32 (step S33). In this case, the relevant category information update unit 38 updates the relevant category information other than the relevant category information corresponding to the category information acquired in the step S32.

When the present time reaches the ending time of the event (YES in step S34) or when the communication unit 31 acquires the switching request more than once (or is within a prescribed range with reference to the event ending time, or is after the event ending time) (YES in step S36), the relevant category information update unit 38 returns the relevant category information updated in the relevant category information storage unit 34 to the initial state (e.g., the state of FIG. 8) (step S35).

A concrete example will be described below with reference to the relevant category information table 34a in FIG. 8 and the facility information table 35a in FIG. 9. For example, when the present time is “11:00”, it's the event starting time of the store H in the event information in the facility information table 35a. Thus, the relevant category information update unit 38 acquires the category information “food” in the step S33. Then, in the relevant category information table 34a, the relevant category information corresponding to the category information “fashion”, “goods” and “service” is updated to “food”. Here, when the information providing server 30 acquires the request for switching the category of the content from the mobile information terminal 20 more than once by the event ending time (YES in the step S36), the relevant category information update unit 38 returns the relevant category information in the relevant category information table 34a corresponding to the category information “fashion”, “goods” and “service” to the initial state as the state before the update (e.g., the state of FIG. 8). Further, when it reaches the event ending time, the relevant category information update unit 38 performs a process of returning the relevant category information to the initial state.

### (1-3) Effect

As described above, in the information providing system 1, the information providing server 30 and the information providing method according to the first embodiment, association between stores (areas) is made by using the position information and the category information on each store, which enables the information providing server 30 to provide the mobile information terminal 20 with information regarding a store to which the user has a high possibility of moving from the present position.

Further, the information providing server 30 reconstructs the relevancy among the stores (i.e., updates and initializes the relevant category information table 34a) in real time based on the event information regarding each of the plurality of stores, by which information suitable for the status of an event can be provided to the mobile information terminal 20 and it becomes possible to provide beneficial information to the user.

Furthermore, the mobile information terminal 20 is capable of acquiring information on a particular store in the facility corresponding to the position of the user and a request from the user according to the transmission data received from the wireless transmission device 10 and the user's simple operation such as the touching operation.

Moreover, the wireless transmission device 10 limits its transmission range and it is possible to communicate the position of a store in the facility and the category to which the store belongs not via a network or the like by use of the position information and the category information included in the transmission data.

In addition, by assigning sequential numbers to values indicating the position information on adjoining stores, like the position information “01” on the store A and the position information “02” on the store B in the transmission data table 71, for example, it is possible to immediately grasp the positional relationship between stores based on the position information included in the transmission data transmitted from the wireless transmission device 10. Accordingly, in the information providing server 30, the provided information extraction unit 37 is capable of easily acquiring the content of a store close to the present position of the user from the facility information storage unit 35 based on the position information.

### (2) Second Embodiment

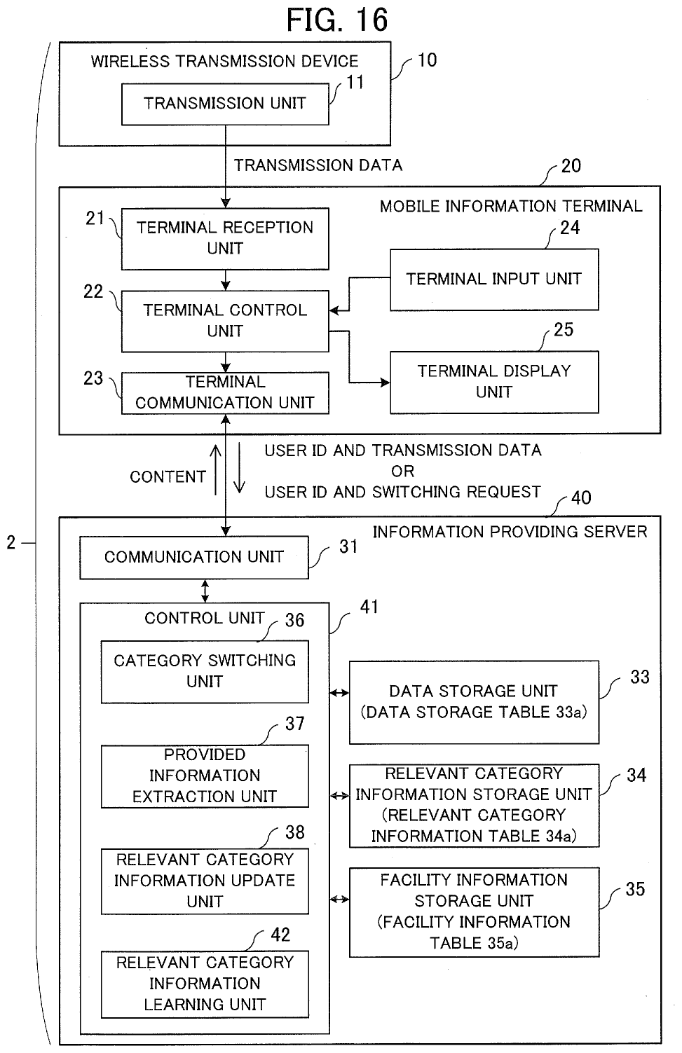

An information providing system 2 according to a second embodiment of the present invention will be described below. FIG. 16 is a functional block diagram schematically showing the configuration of the information providing system 2 according to the second embodiment. The information providing system 2 is a system capable of executing an information providing method according to the second embodiment. In FIG. 16, each component identical or corresponding to a component shown in FIG. 1 is assigned the same reference character as in FIG. 1. The information providing system 2 according to the second embodiment differs from the information providing system 1 according to the above-described first embodiment in that a control unit 41 of an information providing server 40 includes a relevant category information learning unit 42.

In the information providing system 2 according to the second embodiment, information more suitable for the user is provided by constructing the relevancy among the categories for each user based on a past movement path of the user.

The communication unit 31 of the information providing server 40 receives the user ID and the transmission data or the user ID and the switching request from the mobile information terminal 20. When the communication unit 31 receives the user ID and the switching request, the communication unit 31 sends the user ID and the transmission data not only to the relevant category information update unit 38 of the control unit 41 but also to the relevant category information learning unit 42 of the control unit 41.

The relevant category information learning unit 42 acquires all pieces of category information corresponding to the user ID (see FIG. 7, for example) from the data storage unit 33 in chronological order as a category information set. The relevant category information learning unit 42 determines the relevant category information corresponding to the category information based on the category information set acquired from the data storage unit 33. Then, the relevant category information learning unit 42 sends the user ID, the category information, and the relevant category information corresponding to the category information to the relevant category information update unit 38 and thereby updates the relevant category information stored in the relevant category information storage unit 34 (see FIG. 8, for example).

A concrete example will be described below with reference to the data storage table 33a in FIG. 7. For example, when the communication unit 31 of the information providing server 40 acquired the user ID “U01” and the switching request at “2016/10/01, 13:05”, the relevant category information learning unit 42 acquires the category information set “fashion, fashion, food” recorded in the data storage unit 33 in regard to the user having the user ID “U01” from the data storage unit 33 in chronological order. Since the category information set regarding the user ID “U01” acquired from the data storage unit 33 indicates a change from the category information “fashion” to the category information “food”, the relevant category information learning unit 42 considers that the category information “fashion” and the category information “food” are relevant to each other and determines “fashion” as the relevant category information corresponding to the category information “food”.

In this case, it is unnecessary to determine “food” as the relevant category information corresponding to the category information “fashion”. The category information “food” is category information whose degree of necessity by the user changes depending on the time period such as the lunch time and the dinner time, for example, and thus similarly to the first embodiment, the category information “food” is set as the relevant category information corresponding to the category information “fashion”, “goods”, etc. exclusively in certain particular time periods.

The relevant category information update unit 38 updates the relevant category information table 34a stored in the relevant category information storage unit 34 based on the user ID, the category information, and the relevant category information corresponding to the category information acquired from the relevant category information learning unit 42.

The relevant category information storage unit 34 has the relevant category information table 34a for each user having a user ID. Therefore, the relevant category information update unit 38 updates the relevant category information in the relevant category information table 34a corresponding to the user ID. For example, when the relevant category information table corresponding to the user ID “U01” is the relevant category information table 34a and the category information “food” and the relevant category information “fashion” have been acquired from the relevant category information learning unit 42, the relevant category information in the relevant category information table 34a corresponding to the category information “food” is updated to “fashion”.

It is also possible to update the relevant category information corresponding to the category information only when the relevant category information learning unit 42 acquires the same category information set from the data storage unit 33 a predetermined number of times (multiple times). For example, while the relevant category information is updated in the above-described example even when a change in the category information set (change from “fashion” to “food”) occurred only once, it is also possible to change the relevant category information stored in the relevant category information storage unit 34 when a change occurred a prescribed number of times or more.

As described above, in the information providing system 2, the information providing server 40 and the information providing method according to the second embodiment, the degree of relevance between categories to which stores belong (i.e., the correspondence relationship between the category information and the relevant category information) is constructed each time according to the movement of each user, by which information corresponding to the behavior of each user can be provided.

Incidentally, except the features described above, the second embodiment is the same as the first embodiment.

Further, while examples in which the use is limited to the inside of a commercial facility have been described in the first and second embodiments to facilitate the understanding of the details, the information providing systems 1 and 2 are applicable not only to commercial facilities but also to other facilities and places. For example, the information providing system 1 is applicable also to a public facility like a station, a shopping street, and so forth.

### DESCRIPTION OF REFERENCE CHARACTERS

1, 2: information providing system, 10, 10a-10h: wireless transmission device, 11: transmission unit, 20: mobile information terminal, 21: terminal reception unit, 22: terminal control unit, 23: terminal communication unit, 24: terminal input unit, 25: terminal display unit (display), 25b: switching button, 30, 40: information providing server, 31: communication unit, 31: access point, 32, 41: control unit, 33: data storage unit, 33a: data storage table (third data table), 34: relevant category information storage unit, 34a: relevant category information table (second data table), 35: facility information storage unit, 35a: facility information table (first data table), 36: category switching unit, 37: provided information extraction unit, 38: relevant category information update unit, 42: relevant category information learning unit, A-H: store (area).

1. An information providing system comprising:
a mobile information terminal to receive transmission data wirelessly transmitted from a wireless transmission device installed in each area of a plurality of areas, the transmission data including position information and category information on the area in which the wireless transmission device is installed; and
an information providing server to store a first data table including a plurality of pieces of position information, a plurality of pieces of category information and a plurality of pieces of content regarding the plurality of areas and provision item information indicating merchandise or service provided in the plurality of areas and a second data table including a plurality of pieces of relevant category information respectively relevant to the plurality of pieces of category information and to communicate with the mobile information terminal wirelessly, wherein
when the transmission data transmitted from the mobile information terminal is received, the information providing server extracts content corresponding to the provision item information and the category information included in the transmission data from the a plurality of pieces of content included in the first data table and transmits the extracted content to the mobile information terminal, and
when a switching request requesting transmission of content different from most recently received content is received from the mobile information terminal, the information providing server extracts relevant category information relevant to category information corresponding to the most recently received content from the second data table, extracts the content corresponding to the relevant category information from the first data table, and transmits the content corresponding to the relevant category information to the mobile information terminal.

2. The information providing system according to claim 1, wherein
the first data table includes event information including position information on an event held in one of the plurality of areas and a starting time and an ending time of the event, and
the information providing server updates the relevant category information in the second data table based on the event information.

3. The information providing system according to claim 1, wherein
the information providing server stores an acquisition time of the transmission data, the position information and the category information included in the transmission data, and user identification information received together with the transmission data as a third data table when the transmission data transmitted from the mobile information terminal is received, and
the information providing server updates the second data table in regard to each user based on a past movement path of the user acquired from the third data table.

4. An information providing server comprising:
a communication unit to communicate with a mobile information terminal wirelessly that receives transmission data wirelessly transmitted from a wireless transmission device installed in each area of a plurality of areas and the transmission data including position information and category information on the area in which the wireless transmission device is installed;
a facility information storage unit to store a first data table including a plurality of pieces of position information, a plurality of pieces of category information and a plurality of pieces of content regarding the plurality of areas and provision item information indicating merchandise or service provided in the plurality of areas;
a relevant category information storage unit to store a second data table including a plurality of pieces of relevant category information respectively relevant to the plurality of pieces of category information; and
a control unit to extract content corresponding to the provision item information and the category information included in the transmission data from the a plurality of pieces of content included in the first data table and to make the communication unit transmit the extracted content to the mobile information terminal when the transmission data transmitted from the mobile information terminal is received, and to extract relevant category information relevant to category information corresponding to content received most recently by the mobile information terminal from the second data table, to extract the content corresponding to the relevant category information from the first data table, and to make the communication unit transmit the content corresponding to the relevant category information to the mobile information terminal when a switching request requesting transmission of content different from the most recently received content is received from the mobile information terminal.

5. The information providing server according to claim 4, wherein
the first data table includes event information including position information on an event held in one of the plurality of areas and a starting time and an ending time of the event, and
the control unit updates the relevant category information in the second data table based on the event information.

6. The information providing server according to claim 4, further comprising a data storage unit to store an acquisition time of the transmission data, the position information and the category information included in the transmission data, and user identification information received together with the transmission data as a third data table when the transmission data transmitted from the mobile information terminal is received via the communication unit,
wherein the control unit updates the second data table in regard to each user based on a past movement path of the user acquired from the third data table.

7. An information providing method for providing content to a mobile information terminal by wireless communication from an information providing server that stores a first data table including a plurality of pieces of position information, a plurality of pieces of category information and a plurality of pieces of content regarding a plurality of areas and provision item information indicating merchandise or service provided in the plurality of areas and a second data table including a plurality of pieces of relevant category information respectively associated with the plurality of pieces of category information, the method comprising:
receiving transmission data wirelessly transmitted from a wireless transmission device installed in each area of the plurality of areas and the transmission data including position information and category information on the area in which the wireless transmission device is installed, by the mobile information terminal;
extracting content corresponding to the provision item information and the category information included in the transmission data from the a plurality of pieces of content included in the first data table and transmitting the extracted content to the mobile information terminal when the transmission data transmitted from the mobile information terminal is received, by the information providing server; and
extracting relevant category information relevant to category information corresponding to content received most recently by the mobile information terminal from the second data table, extracting the content corresponding to the relevant category information from the first data table, and transmitting the content corresponding to the relevant category information to the mobile information terminal when a switching request requesting transmission of content different from the most recently received content is received from the mobile information terminal, by the information providing server.

8. The information providing system according to claim 2, wherein
the information providing server stores an acquisition time of the transmission data, the position information and the category information included in the transmission data, and user identification information received together with the transmission data as a third data table when the transmission data transmitted from the mobile information terminal is received, and
the information providing server updates the second data table in regard to each user based on a past movement path of the user acquired from the third data table.

9. The information providing server according to claim 5, further comprising a data storage unit to store an acquisition time of the transmission data, the position information and the category information included in the transmission data, and user identification information received together with the transmission data as a third data table when the transmission data transmitted from the mobile information terminal is received via the communication unit,
wherein the control unit updates the second data table in regard to each user based on a past movement path of the user acquired from the third data table.
